(19) United States
(12) Patent Application Publication
(10) Pub. No.: US 2026/0163638 A1
(43) Pub. Date: Jun. 11, 2026

(54) OPTICAL FIBER LINK DELAY MEASUREMENT

(71) Applicant: TELEFONAKTIEBOLAGET LM ERICSSON (PUBL), Stockholm (SE)

(72) Inventors: Fabio CAVALIERE, Pisa (IT); Antonio TARTAGLIA, Genova (IT); Ulf PARKHOLM, Knivsta (SE); Mikael JOHANSSON, Solna (SE)

(21) Appl. No.: 18/707,372

(22) PCT Filed: Nov. 4, 2021
(86) PCT No.: PCT/EP2021/080698

§ 371 Date: May 3, 2024

(51) Int. Cl. H04B 10/071; H04B 10/25

(52) U.S. Cl. CPC H04B 10/071; H04B 10/25

(57) ABSTRACT

An apparatus is configured to determine a delay introduced by an optical fiber link. The apparatus includes a first unit including a first transmitter configured to transmit a first optical signal on the optical fiber link to a second unit, and a first receiver configured to receive a second optical signal on the optical fiber link. A second unit includes a second transmitter and a second receiver, wherein the first and second units are connected by the optical fiber link. The second unit includes a loopback device configured to loop back the first optical signal as a second optical signal to the first unit. Processing circuitry is configured to determine a delay introduced by the optical fiber link for the first optical signal transmitted by the first transmitter and returned as the second optical signal to the first receiver by the loopback device.

### TECHNICAL FIELD

Embodiments of the present disclosure relate to an apparatus and methods for a delay measurement of optical fiber link.

### BACKGROUND

An accurate estimate of the delays in a radio access network is useful for several reasons: meeting the requirements of latency-critical services or time-sensitive fronthaul interfaces, ensuring accurate phase synchronization and guaranteeing time deterministic and symmetric end-to-end delay in uplink and downlink. The optical fiber is one of the significant delay sources in radio transport associated with a radio access network. One kilometer of optical fiber introduces a delay of approximately 5 μs, i.e. each meter of optical fiber introduces a delay of 5 ns. This makes it difficult to estimate the delay with a sub-ns accuracy that is required for latency-critical services or time-sensitive fronthaul interfaces, or for estimating the delay for other reasons.

For example, patch-cords used to connect various equipment units during the installation can be of the order of 1 m. Since the exact length depends on the specific installation environment, the length (and hence the delay) cannot be calculated in advance. Also, the length of an optical fiber link is never known exactly since its length will depend on local bending and splicing points that cannot be exactly determined before its deployment.

Another source of uncertainty of the delay introduced by the optical fiber link comes from the chromatic dispersion of the optical fiber, which is a propagation effect whereby different wavelengths travels at different speed. The propagation delay difference, Δτ, between two wavelengths, λ₁ and λ₁, is

$$Δ τ = {\int }_{{λ}_{1}}^{{λ}_{2}} D ( λ ) aλ \cdot L \qquad Equation 1$$

Where D(λ) is the chromatic dispersion coefficient, measured in ps/(nm·km). Good analytical approximations exist for D(λ) that permit to solve the integral in Equation 1 in closed form. In C band (i.e., the wavelength region between 1530 and 1565 nm) the following linear law holds, where λ̅ is an arbitrary reference wavelength within the considered band:

$$D ( λ ) = D ( \overline{λ} ) + S ( \overline{λ} ) ( λ - \overline{λ} ) \qquad Equation 2$$

A more general approximation, valid also in O band (1260-1360 nm) is given by the equation

$$D ( λ ) = \frac{λ {S}_{0}}{4} [ 1 - {( \frac{{λ}_{0}}{λ} )}^{4} ] \qquad Equation 3$$

Where S₀ is the dispersion slope coefficient, in ps/(nm²·km), at the zero-dispersion wavelength, λ₀.

The above equations require the knowledge of dispersion and dispersion slope coefficients that are known with a certain tolerance, which may not be possible. Further, even without considering the chromatic dispersion effects, the fiber effective refractive index, (typically assumed equal to 1.5, which gives about 200,000 km/s of light speed in fiber) may be slightly different for different cables and can potentially change with temperature.

Direct measurements of the fiber delay may be performed by using Optical Time Domain Reflectometers (OTDR). In order not to cause traffic interruptions, the OTDR transmits at a wavelength different from the optical data signal, and so suffers from delay measurement inaccuracy due to the chromatic dispersion of the optical fiber. The measurements can be made as an initial, non-repeating, event using the same wavelength as the optical data signal, but this makes it difficult to estimate delay variations due to temperature changes during system operation. The effect of temperature is not negligible, for example, for every 1° C. of temperature variation, the optical signal's propagation time through a kilometer of standard fiber can change by 40 picoseconds. Moreover, OTDRs are quite expensive since they must be sensitive to the weak signals that are naturally reflected by the fiber, due to Rayleigh backscattering.

An alternative to OTDR is receiving and retransmitting the same signal to measure its roundtrip delay. To avoid any inaccuracy due to the chromatic dispersion, the retransmitted signal should be at the same wavelength of the transmitted one. This is not compatible with the regular system operation, since the reflected signal could suffer from a large interferometric cross-talk penalty. For an efficient use of the deployed optical fiber, it would be desirable to use the same optical fiber for data transmission in both downstream and upstream directions, and monitor the fiber delay in real time. This can be done either using the same transceivers used for data or a dedicated one. In the second case the dedicated transceiver should be cheap enough not to introduce significant additional costs.

### SUMMARY

An aspect of the disclosure provides an apparatus is configured to determine a delay introduced by an optical fiber link. The apparatus comprises a first unit comprising a first transmitter configured to transmit a first optical signal on the optical fiber link to a second unit, and a first receiver configured to receive a second optical signal on the optical fiber link. A second unit comprises a second transmitter and a second receiver, wherein the first and second units are connected by the optical fiber link.

The second unit comprises a loopback device configured to loop back the first optical signal as a second optical signal to the first unit. Processing circuitry is configured to determine a delay introduced by the optical fiber link for the first optical signal transmitted by the first transmitter and returned as the second optical signal to the first receiver by the loopback device.

A further aspect of the disclosure provides a method of determining a delay introduced by an optical fiber link between a first unit and a second unit. The method comprising configuring a loopback device at the second unit to loop back a first optical signal, transmitted from the first unit, as a second optical signal to the first unit. The method further comprises transmitting the first optical signal on the optical fiber link from the first unit to the second unit. The first and second units are connected by the optical fiber link. The method further comprises receiving the second optical signal at the first unit, and determining a delay introduced by the optical fiber link for the first optical signal transmitted by the first transmitter and returned as the second optical signal to the first receiver by the loopback device.

A further aspect of the disclosure provides a method of determining a delay introduced by an optical fiber link between a first unit and a second unit, the method comprising: receiving signalling to set a loopback device at the second unit to loop back a first optical signal, transmitted from the first unit, as a second optical signal to the first unit. The method further comprises receiving the first optical signal on the optical fiber link from the first unit. The first and second units are connected by the optical fiber link. The method further comprises looping back the first optical signal; and transmitting the second optical signal to the first unit.

### BRIEF DESCRIPTION OF DRAWINGS

For a better understanding of the present disclosure, and to show how it may be put into effect, reference will now be made, by way of example only, to the accompanying drawings, in which:

FIG. 1 is a schematic diagram of an example apparatus configured to determine a delay introduced by an optical fiber link;

FIGS. 2a and 2b are examples of alternative components in the first and/or second units;

FIG. 3 is a further example of an alternative components in the first and/or second units;

FIGS. 4a and 4b are schematic examples of an optical loopback device;

FIG. 5 is an example implementation of an optical loopback device;

FIG. 6 is a graph illustrating delay accuracy and dithering repetition frequency;

FIG. 7 is an example method for the first unit; and

FIG. 8 is an example method for the second unit.

### DETAILED DESCRIPTION

The present disclosure relates to the use of two optical transceivers, referred to as a first and second transceivers, which are connected by an optical fiber link comprising one or more optical fibers. The disclosure relates to measuring the propagation delay of the optical fiber link. At the second transceiver, an optical signal from the first transceiver, is looped back to the first transceiver in order to measure the roundtrip delay introduced by the optical fiber link. The loopback may be carried out electrically or optically.

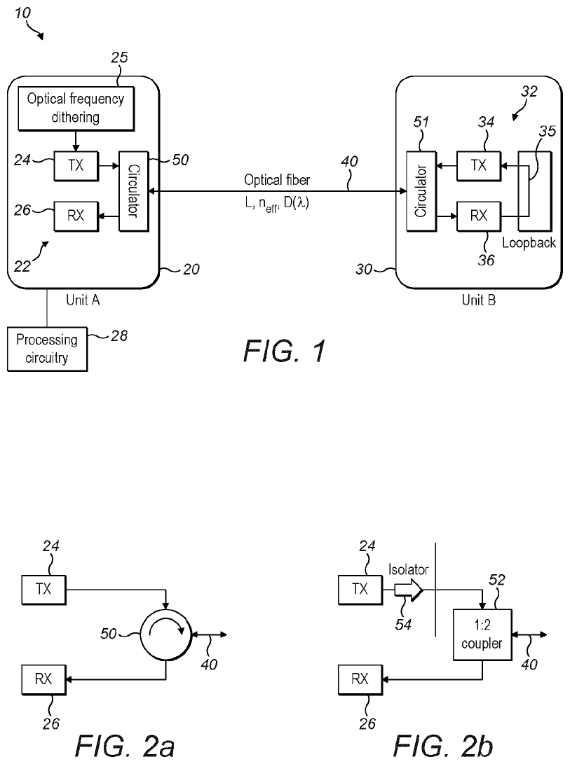

FIG. 1 shows a system 10 according to the present disclosure. The system 10 comprises two units, namely a first Unit A 20 and a second unit B 30, connected by an optical fiber 40. In aspects of the disclosure, the optical fiber is a single optical fiber, i.e. the optical fiber link comprises only a single optical fiber. The same optical fiber carries transmissions in both directions, downstream (DS) and upstream (US) signals, between first Unit A 20 and second Unit B 30.

The first Unit A 20 comprises a first transceiver 22, comprising a first transmitter 24 configured to transmit an optical signal (i.e. a first optical signal) and a first receiver 26 configured to receive an optical signal (i.e. a second optical signal). In this example, the first Unit A further comprises a first optical circulator 50 configured to connect the first transmitter 24 and first receiver 26 to the optical fiber. Alternatively, other optical components may be used to connect the first transmitter 24 and first receiver 26 to the optical fiber, as described below.

Correspondingly, the second Unit B 30 comprises a second transceiver 32, comprising a second transmitter 34 configured to transmit an optical signal (in some examples, the second optical signal) and a second receiver 36 configured to receive an optical signal (in some examples, the first optical signal). The first and second optical signals may be identical, i.e. the same signal pattern, or may be different, e.g. adapted or added to. In this example, the Unit B further comprises a second optical circulator 51 configured to connect the second transmitter 34 and second receiver 36 to the optical fiber. Alternatively, other optical components may be used to connect the second transmitter 34 and second receiver 36 to the optical fiber, as described below.

The transmitters 24,34 at the two units 20,30 are configured to transmit at the same nominal wavelength (i.e. frequency), so that the same propagation delay occurs in the two directions of the optical fiber (also referred to as downstream and upstream). For example, the first and second optical signals use the same channel wavelength. This is because, at the same wavelength, there is no (or minimal) difference in delay due to chromatic dispersion. The transmitters 24,34 at the two units 20,30 do not use exactly only the same wavelength, as will be described.

In one example, there is a small frequency offset (e.g. used in the case of an electrical loopback) between the first and second optical signals. In some examples, the small frequency offset being configured between the downstream and upstream wavelengths is a static offset, i.e. the frequency offset does not change during operation. For the example of the frequency offset, the actual transmission frequencies of the transmitters 24,34 are set to be slightly different, e.g. by acting on the bias of one or both the lasers at the Units A and B. If the downstream or the upstream wavelengths experience a frequency drift, e.g. due to temperature changes, they may overlap, causing errors due to reflections along the optical fiber. In this case, it is sufficient to change the bias value to recover the regular system operation. Remote diagnostic tools, relying on in band (i.e., exploiting the signal frame) or out of band (i.e., amplitude overmodulation) signaling can be used for this purpose. The system sensitivity can be improved by using correlation techniques, i.e. sending a known bit sequences instead of single pulses.

In some examples, the introduced frequency offset between the upstream and downstream optical signals, Δ_{FM} has the same magnitude as the optical bandwidth of the transmitted signal. This reduces possible spectral overlap of the two counterpropagating channels. For example, for an On-Off Keying (OOK) Non Return To Zero (NRZ) signal, the optical bandwidth, Bₒ, is approximately Bₒ˜1.4R_{b}, where R_{b} is the bit rate. Thus, for a signal bit rate of 25 Gbit/s, Δ_{FM}˜35 GHz. The maximum delay measurement inaccuracy over Δ_{FM}, Δτ, due to the chromatic dispersion is shown in FIG. 6.

In a further example, one or both of the transmitters carries out frequency dithering on the transmitted wavelength. This may be used in combination with an optical loopback in particular, or may be used with the electrical loopback. Frequency dithering comprises adding a small frequency offset to the transmitted wavelength, in which the frequency offset changes with time. As such, the frequency offset is time varying. The frequency dithering applies a time varying offset at a dithering frequency, over which all the dithering values are applied. For example, an optical frequency dithering unit 25 is configured to apply a frequency dithering to the optical signal generated by the first transmitter 24. The change in frequency with time may be pseudo-random, random, or follow a pre-set pattern. The frequency dithering introduced on the transmission frequency ensure that the spectra of the signals travelling back and forth along the fiber have no significant overlap or interference. The frequency dithering is an alternative to the frequency offset described above, or may be used in combination. For an example using only a static frequency offset, the optical frequency dithering unit 25 may not be required or present.

At the second Unit B 30, an optical signal from the first transceiver is looped back to the first transceiver in order to measure the roundtrip delay introduced by the optical fiber link. The loopback can be performed in the electrical domain, after photodetection of the optical signal and before re-transmission of the optical signal. In a further aspect, loopback can be performed in the optical domain. In this case, the second transceiver is bypassed using an optical loopback device, e.g. comprising one or more optical switches. In both cases, the loopback can be turned on on-demand, or turned off, for example under the control of a diagnostics interface of the transceiver.

FIG. 1 shows an example of a loopback configuration, in which one of the units, second Unit B 30, comprises a loopback device 35. The loopback device 35 is selectively configured to provide an electrical connection between the receiver 36 and transmitter 34, i.e. electrical loopback. The loopback device 35 may be configured to be activated or not activated, e.g. through a remote configuration. When the loopback device 35 is not activated, regular data transmission can take place, i.e., the loopback device 35 does not provide an operational connection between the receiver 36 and transmitter 34. When the loopback device 35 is not activated, the receiver 36 and transmitter 34 have separate connections to the electrical data interfaces of the Unit B, in order to receive/transmit data from/to the Unit A 20.

In some examples, the second unit comprises a controller (not shown) configured to select whether the loopback device is operational to loop back the first optical signal to the first unit. In some examples, the controller comprises processing circuitry configured to control the loopback device between an activated (operational) state and an inactivated state.

When the loopback device 35 is activated, the loopback device 35 is configured to pass a signal received at the second receiver 36 directly to the second transmitter 34. The second transmitter 34 is configured to transmit the looped back signal to the first Unit A 20. The loopback device 35 is an electrical connection between the receiver 36 and transmitter 34. As such, the optical signal carried on the fiber 40 from the Unit A 20 is converted to an electrical signal by the second receiver 36. If activated, the loopback device 35 transfers the electrical output of the receiver 36, based on the received optical signal, from the receiver 36 and transmitter 34. The transmitter 34 is configured to convert the electrical signal into an optical signal, and transmit the optical signal back to the Unit A 20. The transmitted (i.e. looped back) optical signal may carry identical data to the received optical signal, or the optical signal may be modified by the loopback device 35 or second Unit B, e.g. by addition of a time stamp.

The first Unit A comprises, or is connected to, processing circuitry 28. The processing circuitry 28 is configured to determine a fiber link delay based on measurement of the looped back optical signal. The processing circuitry 28 may be implemented using the same hardware or software as the first Unit A, or as a separate function, at the same or different location. In some aspects, the function of determining the fiber link delay is virtualized. In some examples, the processing circuitry 28 comprises a processor and memory, e.g. implemented as an integrated circuit. In some aspects, information from the first Unit A relating to the first and second optical signals is transmitted to a remote node or location comprising the processing circuitry 28.

The present disclosure provides for two optical transceivers at the two ends of an optical fiber. At one of the transceivers, e.g. at the second unit, the signal is looped back to allow measuring the roundtrip delay. Any delay internal at the transceivers is known and under control and, before transmitting the signal, the transceivers add a timestamp. In some aspects, the two transmitters have the same nominal wavelength but with a static or time-varying frequency offset. The frequency offset is small enough to keep the delay error due to the chromatic dispersion lower than a first design threshold, but large enough to keep the received power penalty or signal outage below a second design threshold. The loopback device can be configured to be operational, or not operational, on-demand, for example, by using signaling or from the diagnostics interface of the transceiver, so facilitating remote network monitoring and automation. Aspects of the disclosure provide for a cost-effective alternative to OTDR to measure with high accuracy the delay introduced by an optical fiber link. Aspects of the disclosure measure the delay in real time, so making possible to monitor delay variations due to environment temperature changes.

It is assumed that any delay internal at the transceiver is either static (i.e. does not change over time) and is known, or, can change dynamically and is reported to the processing circuitry configured to determine the delay. In some examples, before transmitting the signal, one or more of the first and second transceivers (or first and second Units) add a timestamp to provide for measurement of the delay. In some aspects, the timestamp is a time “signal” for when the signal has been held up in the peer end transceiver, or, a local time when signal was received and when the signal was transmitted from the initiating node (Unit A). In correspondence with Precision Time Protocol (PTP), in some examples the timestamps are determined for initial transmission (t1) (i.e. from Unit A), peer end reception (t2) (i.e. at the remote node Unit B), transmission (t3) (i.e. from unit B) and local end reception (t4) (i.e. at Unit A). As for PTP, the delay time for the fiber can be determined from the difference between t2 and t1, and the difference between t4 and t3. The time differences, based on the timestamps, may be determined in the processing circuitry 28.

FIGS. 2a and 2b show example components for connecting the first transmitter 24 and first receiver 26 to the optical fiber 40 link. The same components and configurations are also applicable for connecting the second transmitter 34 and second receiver 36 to the optical fiber link 40.

In FIG. 2a, an optical circulator 50 is used to couple the transmitter and receiver to the same optical fiber 40. The circulator 50 connects a first optical signal from the transmitter 24 to the optical fiber link 40, and connects a received second optical signal to the receiver 26.

FIG. 2b shows an alternative implementation of the first or second unit 20,30, in which the transmitter 24 and receiver 26 are connected to the optical fiber 40 using one or more different optical components. For example, FIG. 2b shows a power splitter 52 and isolator 54 configured to optically couple the transmitter 24 and receiver 26 to the optical fiber 40. The power splitter 52 may also be considered as a 1:2 coupler. The isolator 54 is configured to allow optical signals to pass in one direction only, i.e. only allow optical signals transmitted from the transmitter 24 towards the power splitter 52.

For receiving an optical signal at the Unit 20, the power splitter 52 is configured to split an optical signal received over the optical fiber 40, one output towards the transmitter and one output towards the receiver. In some examples, the splitter may be an unbalanced splitter. For example, the splitting ratio is adjusted to be compatible with the transmitter power and the receiver power values fixed by system specifications. In other examples, the splitter may equally split the received power. The optical signal towards the transmitter 24 is blocked by the isolator 54, since the direction of this optical signal is opposite to the direction allowed to pass by the isolator. The optical signal output from the power splitter 52 towards the receiver 26 is received by the receiver 26.

For transmitting an optical signal from the unit 20, the transmitter 24 transmits the optical signal through the isolator 54 and towards the power splitter 52. The power splitter 52 is configured to pass the optical signal onto the optical fiber 40, on which it is transmitted to the remote node, i.e. second Unit 30.

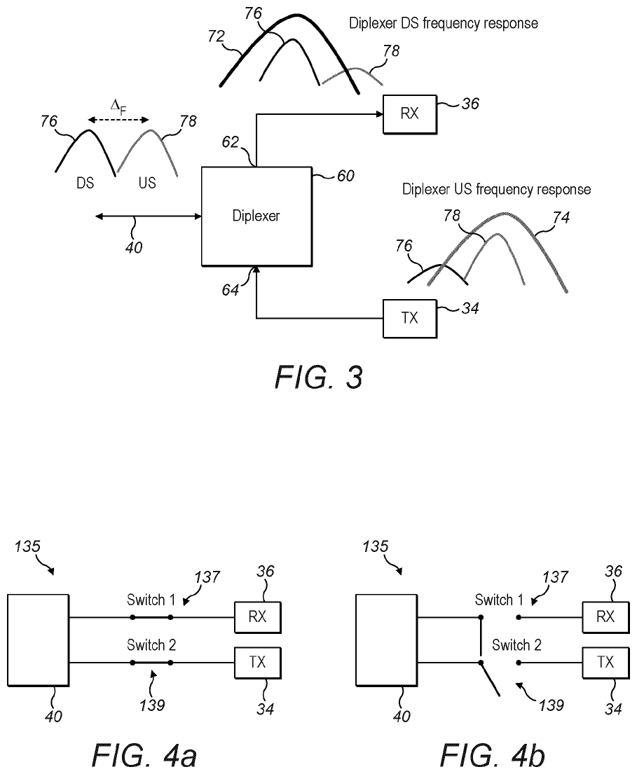

FIG. 3 shows a further example of an optical component used to connect the transmitters 24,34 and receivers 26,36 to the optical fiber 40. In this example, a diplexer 60, also known as a three-port optical filter, is used. At high bit rates (e.g. 25 Gbit/s), Δ_{FM} becomes high enough to use the diplexer 60. The diplexer may be used instead of the circulator 50. The diplexer 60 may provide a cost-effective solution to separate downstream and upstream optical signals.

The diplexer 60 provides for a different frequency response on the upstream and downstream directions. As such, the diplexer 60 acts as a filter with different passbands on its upstream and downstream ports. For example, on the downstream port 62 for reception, the diplexer 60 has a filter frequency response 72 which effectively selects the downstream optical signal 76. On an upstream port 64 for transmission, the diplexer 60 has a filter frequency response 74 which effectively selects the upstream (first) optical signal 78. This provides for the upstream and downstream (first and second) optical signals 76,78 which are both transmitted on the optical fiber 40 to be separated and effectively output to the intended upstream port 64 or downstream port 62. The first and second optical signals 76,78 have a frequency offset, as described above.

Using a diplexer has the advantage that any large drift of the transmitter (e.g. laser) wavelength leads to changes of the received optical power, which may be used to readjust the laser bias (i.e. wavelength). An alternative is to use detected errors to detect a drift of the laser wavelength.

As an alternative, using transmitters emitting at two different nominal frequencies would simplify the system implementation, since dithering or frequency offset are no longer needed. However, the determined delay would be less accurate due to the chromatic dispersion between the two frequencies. For example, the determined delay would be almost 230 ps for two 800 GHz spaced channels in the O-band (i.e. in the 1310 nm region) propagating over 10 km of optical fiber. Thus, the presently described examples use a small frequency offset, e.g. approximately the same value or magnitude as the optical bandwidth, or using dithering of the frequency of one of the transmitted optical signals. As such, the two wavelengths used (either with a static or time-varying dithered frequency separation) are using the same optical channel.

In some examples, the loopback device is an optical loopback device where the loopback is performed in the optical domain, by means of one or more optical switches between a circulator (or other component providing for connection of the optical fiber link to the transceivers) and the transceiver. This is an alternative to the example of the electrical loopback device.

FIGS. 4a and 4b show an example implementation of an optical loopback device 135. The optical loopback device 135 is configured to selectively loop back optical signals received at the Unit B 30, without involving the second receiver 36 or second transmitter 34. The loopback device 135 may be considered functionally as comprising a first optical switch 137 and a second optical switch 139. The loopback device 135 performs the loopback in the optical domain. For example, the first optical switch 137 and the second optical switch 139 are located between the circulator 50 and transceiver 34,36 of FIG. 1. The switches 137,139 may be controlled by a controller, e.g. comprising processing circuitry (not shown).

In FIG. 4a, the first optical switch 137 and the second optical switch 139 are configured for a mode for regular data transmission, i.e. the loopback device is inactive or not operational. The first optical switch 137 is configured to provide an optical connection between the receiver 36 and the optical fiber 40. The second optical switch 139 is configured to provide an optical connection between the transmitter 34 and the optical fiber 40. In this mode, the loopback device 135 provides for regular data transmission, i.e. no loopback of an optical signal.

In FIG. 4b, the first optical switch 137 and second optical switch 139 are shown in a mode for loopback of the optical signal, i.e. the loopback device is active. The first optical switch 137 is configured to break an optical connection between the receiver 36 and the optical fiber 40. The second optical switch 139 is configured to break an optical connection between the transmitter 34 and the optical fiber 40.

In this loopback mode, the first optical switch 137 (and/or second optical switch 139) functionally provides an optical connection to the second optical switch 139. As such, the first and second optical switches 137,139 provide an optical connection for an optical signal received at the Unit B 30 directly to an optical output port of the Unit B 30. The optical connection provided by the first and second optical switches 137,139 provides a loop back of an optical signal received from the Unit A 20, back to the Unit A 20, without involving the transmitter 34 or receiver 36. In this state, the loopback device 135 does not provide for regular data transmission.

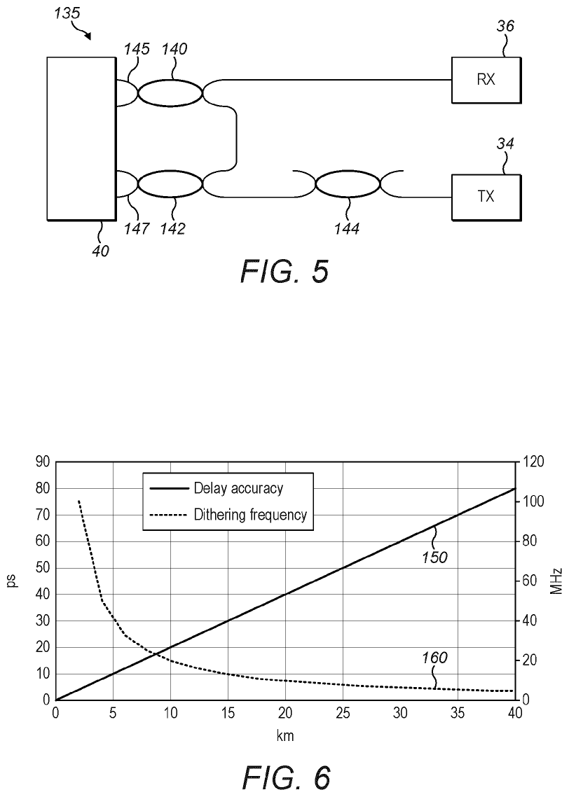

FIG. 5 shows an example of an implementation of the optical loopback device 135 using Mach Zehnder interferometers, MZI. This example is suitable for implementation using, for example, silicon photonics. In this example, the loopback device 135 comprises a first MZI 140, a second MZI 142 and a third MZI 144. The loopback device 135 comprises an input optical port 145 configured to receive optical signals, and an output optical port 147 configured to transmit optical signals. In the example of FIG. 1, the input optical port 145 output optical port 147 are connected to the circulator 50.

In the regular data transmission mode (corresponding to FIG. 4a), all MZI are in pass-through mode. In the regular data transmission mode, the first MZI 140 connects the input optical 145 port of the loopback device 135 to the receiver 36. The second MZI 142 and the third MZI 144 connect the output optical port 147 to the transmitter 34. As such, the loopback device is not operational and the second unit B 30 operates to communicate date with the first unit A 20 according to a normal data operation.

In a loopback mode, i.e. the loopback device 135 is operational, (corresponding to FIG. 4b), all MZI 140,142,144 are configured to be in cross-connect mode. In this mode, the first and second MZI 140,142 are configured to connect to each other. This optical connection of the first and second MZI 140, 142 provides for optical loop back, since the input optical port 145 and output optical port 147 are directly connected. The third MZI 144 is configured to output any optical signal, e.g. from the transmitter 34, to an unconnected output. This ensures that any optical signal generated by the transmitter 34 is not transmitted on the output optical port 147.

The optical implementation of the loopback device 135 has the advantage of allowing the use of different transmission wavelengths at the two ends of the optical fiber link. This is since individual and independent delay measurements can be performed by each one of the two transceivers, at different times. This would also allow to measure the chromatic dispersion coefficient of the fiber.

In some examples, the first Unit A 20 is configured to dither the optical frequency of the transmitter to decrease the probability that colliding signals travelling back and forth have the same current wavelength. This mitigates the occurrence of penalties from reflections along the optical path. Similar to the electrical loopback case, the frequency modulation depth, Δ_{FM}, induced by the dithering signal should be comparable to the optical bandwidth of the transmitted signal, to reduce the overlap of the two spectra of the two counterpropagating channels. For a 25 Gbit/s bit rate signal, Δ_{FM}˜35 GHz.

In some examples, a high value of modulation depth may be achieved when the transceiver is used for delay monitoring purpose and is cost-effectively implemented at low bit rates (e.g., 1 Mbit/s or lower). Using a low bit-rate does not negatively affect the delay measurement accuracy. For example, Digital Dual Mixer Time Difference techniques may be used for this purpose.

The maximum delay measurement inaccuracy, Δτ, due to the chromatic dispersion for a modulation depth (or a frequency offset) Δ_{FM} is defined by Equation 4:

$$Δ τ = D L \frac{{λ}^{2} 2 {Δ}_{F M}}{c} \qquad Equation 4$$

Where D is the chromatic dispersion coefficient of the fiber, L is the fiber length, λ is the channel wavelength and c is the light speed in vacuum. In an example, e.g. as shown in FIG. 6, example values are D=5 ps/nm/km and λ=1310 nm.

FIG. 6 shows the variation with optical fiber link length for two parameters. Line 150 shows the maximum delay measurement inaccuracy, Δτ, in picoseconds as defined by Equation 4, with increasing optical fiber link length (in km). Line 150 shows that the delay measurement inaccuracy, due to the chromatic dispersion from the frequency offset, dithering frequency or modulation depth, increasing linearly with fiber length. When more than a single frequency is used, the chromatic dispersion leads to a corresponding spread of the propagation delay, which is a source of inaccuracy. The delay measurement inaccuracy, Δτ, increases with increasing length of the optical fiber link.

The frequency dithering has a magnitude, defined in terms of frequency, by which the transmission frequency is modified by the dithering. As described above, the magnitude of the frequency dithering may be as described for the frequency offset, for example, approximately the bandwidth of the transmission, e.g. approximately 35 GHz. In other examples, the magnitude of the frequency dithering, or frequency offset, may be one or more of: greater than 20 GHz, greater than 35 GHz, greater than 50 GHz, and/or, less than 30 GHz, less than 40 GHz, less than 50 GHz. In addition, the frequency dithering is a repeating pattern of different frequency offsets. As a repeating pattern, there is a time period (or frequency) at which the dithering pattern repeats. The repetition frequency may be referred to as the dithering repetition frequency, to differentiate from the frequency magnitude of the frequency dithering.

FIG. 6 further shows a line 160 indicating a minimum frequency of the dithering repetition frequency, described above, in MHz. The minimum frequency 160 shown is the inverse of the one-way delay of the optical signal in fiber, L·n_{eff}/c″. The dithering repetition frequency is higher than the inverse of the one-way delay of the optical signal in the fiber.

The minimum dithering repetition frequency 160 is highest for the shortest length of optical fiber length. As the optical fiber length increases, the minimum frequency 160 of the dithering repetition frequency decreases.

To explain this, an inverse of the dithering repetition frequency (1/Df) may be considered as an “equivalent time domain pulse” associated with the dithering, which has a length in the time domain. This length in the time domain needs to be smaller than the single ended propagation delay. As such, the “equivalent time domain pulse” is shorter than the time taken for the pulse to travel along the length of the optical fiber link. Thus, along the length of the fiber, all values of the frequency dithering would be used, in a pseudo-random arrangement. This provides for an effective dithering. In particular, this minimum value of the dithering repetition frequency ensures that a “quasi-static” situation is avoided, in which the frequency of the dithering repetition frequency is too low, and lengths of the fiber would experience the same frequency offset, i.e. the dithering would be ineffective at making sure the reflected pulse has a minimum offset when it passes the forward pulse. So the shorter the fiber link L, the shorter must be this “equivalent time domain pulse” associated to dithering. In some aspects, the dithering frequency must be higher than the value in the orange curve (Df>1/L×n_{eff}/c). Thus, the dithering repetition frequency, selected according to this minimum value, avoids the reflected optical pulse appearing as “in-band” noise for the forward pulse.

In some examples, the dithering repetition frequency, is less than 200 MHz or less than 100 MHz or less than 50 MHz or less than 20 MHz, and/or, the dithering repetition frequency is more than 100 MHz, or more than 50 MHz, or more than 20 MHz.

In this example, the values used are D=5 ps/nm/km and λ=1310 nm. The value of n_{eff}˜1.5 is the considered effective group refractive index of the fiber.

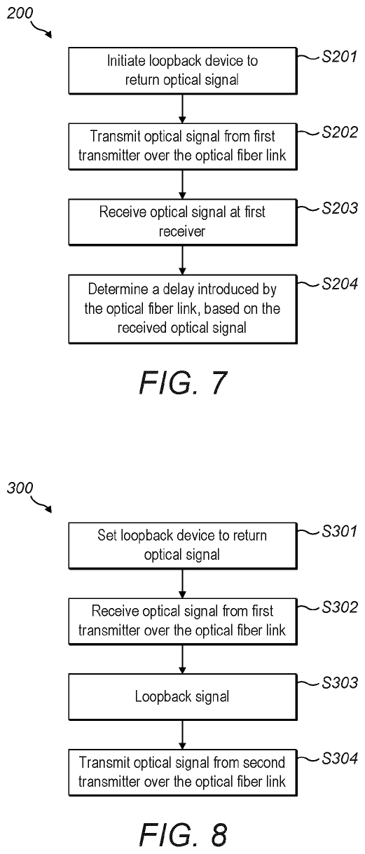

FIG. 7 shows a method 200 of determining a delay introduced by the optical fiber link.

In S201, a loopback device is initiated in a second node, e.g. Unit B 30. In some examples, the loopback device is initiated using signalling from a first node, e.g. Unit A 20, e.g. sent over the fiber optical link for which the delay is to be measured.

In S202, the first node transmits an optical signal from a first transmitter over the optical fiber link, to the second node, e.g. Unit B 30. The loopback device at the second node is configured to return or re-transmit the optical signal, using the electrical or optical loopback device, as described above.

In 203, the second node receives the returned or re-transmitted optical signal over the optical fiber link.

In S204, the second node determines a delay introduced by the optical fiber link. In some examples, the processing circuitry is configured to determine the time delay. For example, the second node determines the time delay from a recorded time take for the optical signal to be transmitted and returned, e.g. from determining the transmission and receiving time, timestamps or a correlation of the pattern of the transmitted and received signals. In further aspects, information determined by the second node 20 is transmitted to a further node or virtualized processing function in order to determine the time delay. In some aspects, the calculated time delay may be transmitted to another node, for example, for use in synchronization of the network.

FIG. 8 shows a method 300 carried out in a Unit B 30, to provide for determining a delay introduced by the optical fiber link.

In S301, the second Unit B 30 signalling is received to set, or initiate operation of, the loopback device. The signalling is received from the first Unit A 20, or another node, e.g. a control or management node. The second Unit B 30 sets the loopback device to return an optical signal. For example, for an electrical loopback device 35, the loopback device is configured to electrically connect the receiver 36 to the transmitter 32, either directly or via processing circuitry to modify the received signal. For an optical loopback device 135, the loopback device is re-configured to return the optical signal back to the first Unit A 20, e.g. without use of the receiver 36 and transmitter 34. As described above, the second Unit B 30 configures one or more optical switches to form a return loop, in order to return the received optical signal.

In S302, the second Unit B 30 receives the optical signal from the transmitter of the first Unit A 20. The optical signal is received by the optical loopback device 135, or received by the receiver 36 and converted to an electrical signal, which is passed to the electrical loopback device 35.

In S303, the loopback device 35; 135 functions to return (i.e. loop back) the signal to the originating node. For the optical loopback device 135, the optical signal transits the loopback device 135 and transfers directly onto a transmission port of the second Unit B 30 (optionally via an optical amplifier, not shown). For the electrical loopback device 35, the electrical loopback device 35 passes the electrical signal to the transmitter 34. In some aspects, the second Unit B modifies the electrical signal with a timestamp or other modifications.

In S304, the second Unit B 30 transmits the optical signal over the optical fiber link. The transmitted optical signal is either identical to the received signal or modified, e.g. by addition of a timestamp. For the optical loopback device 135, the optical signal may be considered as transmitted by the loopback device 135. For the electrical loopback device 35, the optical signal is transmitted by the transmitter 34.

In general, the various exemplary embodiments may be implemented in hardware or special purpose circuits, software, logic or any combination thereof. For example, some embodiments may be implemented in hardware, while other embodiments may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like. References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms. References to an apparatus may refer to an individual node or a system. Any feature described may be defined separately from any other feature. For example, the features implemented by a single node may be defined and claimed without reference to one or more other nodes.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. An apparatus configured to determine a delay introduced by an optical fiber link, the apparatus comprising:
a first unit comprising a first transmitter configured to transmit a first optical signal on the optical fiber link to a second unit, and a first receiver configured to receive a second optical signal on the optical fiber link;
a second unit comprising a second transmitter and a second receiver, wherein the first and second units are connected by the optical fiber link, and
wherein the second unit comprises a loopback device configured to loop back the first optical signal as a second optical signal to the first unit; and
processing circuitry configured to determine a delay introduced by the optical fiber link for the first optical signal transmitted by the first transmitter and returned as the second optical signal to the first receiver by the loopback device.

2. The apparatus as claimed in claim 1, wherein the second unit comprises a controller configured to select whether the loopback device is operational to loop back the first optical signal to the first unit.

3. The apparatus as claimed in claim 1, wherein the first and second optical signals have a same nominal frequency, and a frequency offset which is static or time-varying.

4. The apparatus as claimed in claim 3, wherein the frequency offset has a same magnitude as an optical bandwidth of the first or second optical signal.

5. The apparatus as claimed in claim 3, wherein the time-varying frequency offset comprises an optical frequency dithering.

6. The apparatus as claimed in claim 1, wherein the loopback device is an optical loopback device configured to bypass the second transmitter and second receiver to loop back the first optical signal as the second optical signal to the first unit.

7. The apparatus as claimed in claim 6, wherein the optical loopback device comprises a plurality of optical switches.

8. The apparatus as claimed in claim 1, wherein the loopback device is an electrical loopback device configured to connect an electrical output of the second receiver with an electrical input of the second transmitter, such that the second transmitter transmits the second optical signal to the first unit.

9. The apparatus as claimed in claim 1, wherein the optical fiber link comprises a single fiber.

10. The apparatus as claimed in claim 1, wherein a timestamp is added by the first unit and/or second unit.

11. The apparatus as claimed in claim 1, wherein the first unit and/or second unit comprises one of: an optical circulator, coupler, filter and diplexer between the optical fiber link and the first transmitter and first receiver and between the optical fiber link and the second transmitter and second receiver.

12. A method of determining a delay introduced by an optical fiber link between a first unit and a second unit, the method comprising:
configuring a loopback device at the second unit to loop back a first optical signal, transmitted from the first unit, as a second optical signal to the first unit;
transmitting the first optical signal on the optical fiber link from the first unit to the second unit,
wherein the first and second units are connected by the optical fiber link;
receiving the second optical signal at the first unit, and
determining a delay introduced by the optical fiber link for the first optical signal transmitted by the first transmitter and returned as the second optical signal to the first receiver by the loopback device.

13. The method as claimed in claim 12, wherein the first and second optical signals have a same nominal frequency, and a frequency offset which is static or time-varying.

14. A method of determining a delay introduced by an optical fiber link between a first unit and a second unit, the method comprising:
receiving signalling to set a loopback device at the second unit to loop back a first optical signal, transmitted from the first unit, as a second optical signal to the first unit;
receiving the first optical signal on the optical fiber link from the first unit, wherein the first and second units are connected by the optical fiber link;
looping back the first optical signal; and
transmitting the second optical signal to the first unit.

15. The method as claimed in claim 14, wherein the loopback device is an optical loopback device configured to bypass a second transmitter and a second receiver to loop back the first optical signal as the second optical signal to the first unit.

16. The method as claimed in claim 15, wherein the optical loopback device comprises a plurality of optical switches.

17. The method as claimed in claim 14, wherein the loopback device is an electrical loopback device connecting an electrical output of the second receiver with an electrical input of the second transmitter, such that the second transmitter transmits the second optical signal to the first unit.

18. The method as claimed in claim 12, wherein the optical fiber link comprises a single fiber.

19. The method as claimed in claim 12, comprising adding a timestamp at the first unit and/or second unit.
